(19) United States
(12) Patent Application Publication
(10) Pub. No.: US 2014/0136957 A1
(43) Pub. Date: May 15, 2014

(54) Supporting Scalable Fonts

(71) Applicant: MONOTYPE IMAGING INC., Woburn, MA (US)

(72) Inventors: Sampo Juhani Kaasila, Plaistow, NH (US); Anand Vijay, Lalghati (IN)

(73) Assignee: Monotype Imaging Inc., Woburn, MA (US)

(21) Appl. No.: 13/672,992

(22) Filed: Nov. 9, 2012

(51) Int. Cl. G06F 17/21

(52) U.S. Cl. 715/235

(57) ABSTRACT

A system includes a first computing device that includes a memory configured to store instructions. The first computing device also includes a processor to execute the instructions to perform operations that include receiving information that indicates whether an asset presenter being executed by a computing device is capable of presenting one or more typographic features of a web asset represented in a scalable font format. Operations also include, in response to receiving the information, sending font information to the computing device to allow the one or more typographic features of the web asset represented in the scalable font format to be presented by the computing device.

### BACKGROUND

This description relates to techniques for allowing computing devices to support scalable fonts for presentation.

In the ever-expanding connectivity and information sharing capabilities provided by computer networks such as the Internet, various types of web assets such as websites, webpages, etc. have been developed to assist with the transfer of information. Along with the almost explosive development of web assets, the content being presented by the assets has similarly grown. Text, graphics, audio, video, etc. is being incorporated into web assets to provide a more efficient and enjoyable viewing experience. For example, different languages, imagery, etc. may be included in web assets to tailor content for characteristics of a viewer such as their geographical location. However, providing such rich content does not experience some constraints. For example, the functionality of computing devices, operating systems, software, etc. may limit a viewer's ability to view and enjoy all of the content types that could be provided.

### SUMMARY

The systems and techniques described here relate to determining if a web browser (or other type of asset presenter) is capable of supporting typographic features of a web asset (e.g., a website webpage, etc.) represented in the scalable font format. Appropriate action can be taken based upon the determination. For example, if capable of supporting the features, font information may be provided to the web browser for appropriately presenting the web asset. If not supported by the web browser, font information may be modified and provided such that the web browser can present the typographical features. By providing the ability to present such rich content through these features, viewer experiences may be improved along with their interest in the web asset being presented.

In one aspect, a computer-implemented method includes receiving information that indicates whether an asset presenter being executed by a computing device is capable of presenting one or more typographic features of a web asset represented in a scalable font format. The method also includes, in response to receiving the information, sending font information to the computing device to allow the one or more typographic features of the web asset represented in the scalable font format to be presented by the computing device.

Implementations may include one or more of the following features. Sending font information may include sending a font file to the computing device. Sending font information may include modifying a font file prior to sending the font file to the computing device. Modifying the font file may include adding one or more character codes to the font file for accessing corresponding glyph shapes. Modifying the font file may include removing a portion of the font file. Modifying the font file may include removing a portion of a table from the font file. Modifying the font file may include removing a portion of a glyph substitution table. Sending the font information may include sending a file executable by the asset presenter that contains logic for presenting the typographical features of the web asset represented in the scalable font format. The information that indicates whether the asset presenter is capable of presenting one or more typographic features of a web asset represented in a scalable font format may be based on operations executed by a font service provider. The information that indicates whether the asset presenter is capable of presenting one or more typographic features of a web asset represented in a scalable font format may be based on operations executed by the computing device. The operations executed by the computing device may include reading a cascading style sheet file for determining the typographical features of the web asset. The operations executed by the asset presenter may include reading information provided from a hypertext markup language file for determining the typographical features of the web asset. The web asset presenter may read a document object model for the information provided from the hypertext markup language file. The document object model may be modified to include a representation of the one or more typographical features of the web asset represented in a scalable font format. The font file may include data for a subset of typographical features based on the typographical features of the web asset. The font file may include data for a subset of characters based on the content of the web asset. The asset presenter may include one of a web browser, a web-based application and a web view application. The font information may include the typographical features of the web asset represented in the scalable font format, is absent typographical features that are absent from the web asset, and is provided in one or more files. The font information may include the typographical features of the web asset represented in the scalable font format, is absent typographical features that are absent from the web asset, and is provided in one file concatenated from two or more other files. The sent font information may include one or more operations with names that identify one or more typographical features.

In another aspect, a system includes a first computing device that includes a memory configured to store instructions. The first computing device also includes a processor to execute the instructions to perform operations that include receiving information that indicates whether an asset presenter being executed by a computing device is capable of presenting one or more typographic features of a web asset represented in a scalable font format. Operations also include, in response to receiving the information, sending font information to the computing device to allow the one or more typographic features of the web asset represented in the scalable font format to be presented by the computing device.

Implementations may include one or more of the following features. Sending font information may include sending a font file to the computing device. Sending font information may include modifying a font file prior to sending the font file to the computing device. Modifying the font file may include adding one or more character codes to the font file for accessing corresponding glyph shapes. Modifying the font file may include removing a portion of the font file. Modifying the font file may include removing a portion of a table from the font file. Modifying the font file may include removing a portion of a glyph substitution table. Sending the font information may include sending a file executable by the asset presenter that contains logic for presenting the typographical features of the web asset represented in the scalable font format. The information that indicates whether the asset presenter is capable of presenting one or more typographic features of a web asset represented in a scalable font format may be based on operations executed by a font service provider. The information that indicates whether the asset presenter is capable of presenting one or more typographic features of a web asset represented in a scalable font format may be based on operations executed by the computing device. The operations executed by the computing device may include reading a cascading style sheet file for determining the typographical features of the web asset. The operations executed by the asset presenter may include reading information provided from a hypertext markup language file for determining the typographical features of the web asset. The web asset presenter may read a document object model for the information provided from the hypertext markup language file. The document object model may be modified to include a representation of the one or more typographical features of the web asset represented in a scalable font format. The font file may include data for a subset of typographical features based on the typographical features of the web asset. The font file may include data for a subset of characters based on the content of the web asset. The asset presenter may include one of a web browser, a web-based application and a web view application. The font information may include the typographical features of the web asset represented in the scalable font format, is absent typographical features that are absent from the web asset, and is provided in one or more files. The font information may include the typographical features of the web asset represented in the scalable font format, is absent typographical features that are absent from the web asset, and is provided in one file concatenated from two or more other files. The sent font information may include one or more operations with names that identify one or more typographical features.

In another aspect, one or more computer readable media storing instructions that are executable by a processing device, and upon such execution cause the processing device to perform operations that include receiving information that indicates whether an asset presenter being executed by a computing device is capable of presenting one or more typographic features of a web asset represented in a scalable font format. Operations also include, in response to receiving the information, sending font information to the computing device to allow the one or more typographic features of the web asset represented in the scalable font format to be presented by the computing device.

Implementations may include one or more of the following features. Sending font information may include sending a font file to the computing device. Sending font information may include modifying a font file prior to sending the font file to the computing device. Modifying the font file may include adding one or more character codes to the font file for accessing corresponding glyph shapes. Modifying the font file may include removing a portion of the font file. Modifying the font file may include removing a portion of a table from the font file. Modifying the font file may include removing a portion of a glyph substitution table. Sending the font information may include sending a file executable by the asset presenter that contains logic for presenting the typographical features of the web asset represented in the scalable font format. The information that indicates whether the asset presenter is capable of presenting one or more typographic features of a web asset represented in a scalable font format may be based on operations executed by a font service provider. The information that indicates whether the asset presenter is capable of presenting one or more typographic features of a web asset represented in a scalable font format may be based on operations executed by the computing device. The operations executed by the computing device may include reading a cascading style sheet file for determining the typographical features of the web asset. The operations executed by the asset presenter may include reading information provided from a hypertext markup language file for determining the typographical features of the web asset. The web asset presenter may read a document object model for the information provided from the hypertext markup language file. The document object model may be modified to include a representation of the one or more typographical features of the web asset represented in a scalable font format. The font file may include data for a subset of typographical features based on the typographical features of the web asset. The font file may include data for a subset of characters based on the content of the web asset. The asset presenter may include one of a web browser, a web-based application and a web view application. The font information may include the typographical features of the web asset represented in the scalable font format, is absent typographical features that are absent from the web asset, and is provided in one or more files. The font information may include the typographical features of the web asset represented in the scalable font format, is absent typographical features that are absent from the web asset, and is provided in one file concatenated from two or more other files. The sent font information may include one or more operations with names that identify one or more typographical features.

These and other aspects and features and various combinations of them may be expressed as methods, apparatus, systems, means for performing functions, program products, and in other ways.

Other features and advantages will be apparent from the description and the claims.

### DESCRIPTION OF DRAWINGS

FIG. 1 illustrates a mobile device presenting text content.

FIG. 2 is a block diagram of an Internet based computer network.

FIG. 3 illustrates a font service provider providing font information to computing devices.

FIG. 3a illustrates an editor.

FIG. 4 illustrates presentable content for computing devices.

FIGS. 5 and 6 are portions of hypertext markup language (HTML) files.

FIG. 7 is an example flow chart of operations of a font service manager.

FIG. 8 is a block diagram showing an example of a system for providing hosted storage and accessing the hosted storage from a client device.

FIG. 9 illustrates an example of a computing device and a mobile computing device that can be used to implement the techniques described here.

### DETAILED DESCRIPTION

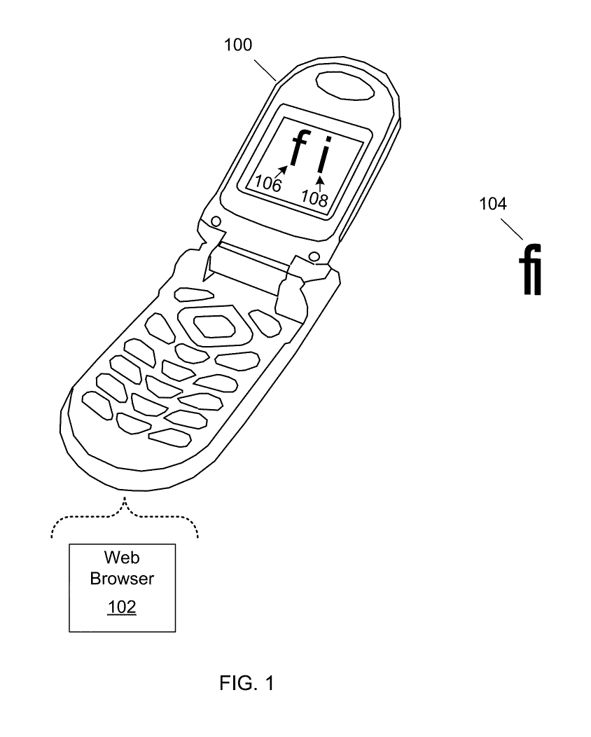

Referring to FIG. 1, many types of computing devices are capable of presenting various types of graphical content such as text, images, video, etc. To present text and similar graphics, various types of font families (e.g., Times New Roman, Arial, etc.) may be used that typically include a set of fonts, e.g., regular, italic, bold, bold italic, etc. Each font generally includes a set of individual character shapes called glyphs and each glyph can be distinguished by its various design features (e.g., geometry, stroke thickness, serifs, size, etc.). One or more techniques may be utilized for representing such fonts; for example, outline-based representations may be adopted in which lines and curves are used to define the borders of glyphs. Such fonts may be scalable for a variety of sizes (e.g., for rending by various computing devices) and may be represented in one or more formats. For example, scalable outline fonts may be represented in a format that includes data structures capable of supporting a variety of typographic visual symbols of many languages. OpenType is one such format capable of defining a number of typographical features that one or more scalable computer fonts may support. Features may include, for example, providing a typographical flourish on a glyph (referred to as a swash), two or more graphemes joined as a single glyph (referred to as a ligature), representing fractions as a single character (e.g., ½), etc. Formats such as the OpenType may also support typographical features that provide contextual alternatives to a character, word, phrase, etc. For example, rather than presenting the character “I” in the phrase “I caught a lovely silver fish”, a graphical alternative “ [symbol] ” may be inserted into the phrase to read “ [symbol] caught a lovely silver fish”. Subscripting and superscripting, variants on capital letters (e.g., small versions of capital letters) etc. may also be supported by formats (such as OpenType) for scalable fonts.

As illustrated in the figure, some devices, operating systems and software applications may or may not be capable of supporting OpenType format for scalable computer fonts. In this illustrated example, a cellular telephone 100 is executing an asset presenter (e.g., web browser application 102) to present content transmitted by one or more networks (e.g., the Internet) from a variety of sources. In this situation, the web browser 102 does not support OpenType fonts and is unable to present content in typographical features provided by OpenType fonts. For example, rather than presenting a single character of the ligature “fi” 104, the web browser 102 presents two individual characters “f” 106 and “i” 108. Based upon the browser being executed by a user computing device, font formats such as OpenType may or may not be supported and content from an author may not be presented as originally prepared. However, by knowing the capabilities of a device, its operating system, executed applications, etc., information may be prepared and provided to the device so it can be capable of properly presenting the content as originally created.

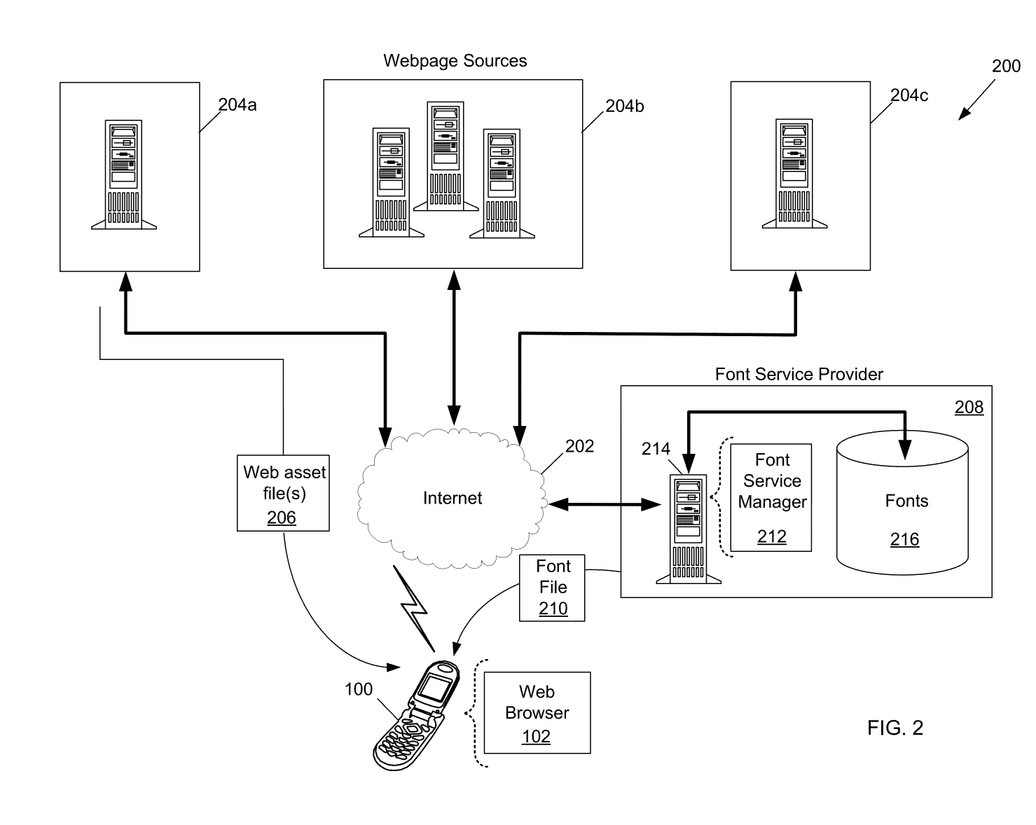

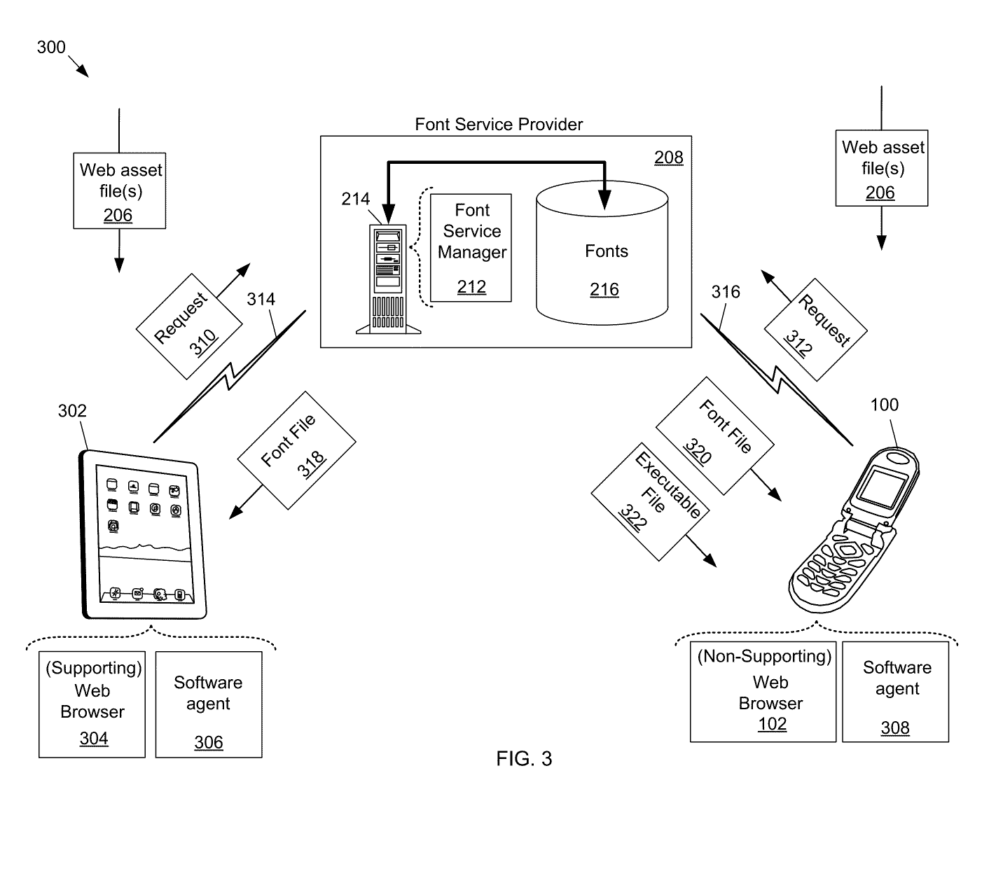

Referring to FIG. 2, a computing environment 200 includes a computing device (e.g., the cellular telephone 100) that a user may interact with (e.g., using a keypad, etc.) to identify a target web asset (e.g., website, webpage, etc.) for being presented by the computing device. For example, the web browser 102 or other type of asset presenter (e.g., a software application) may be executed by the cellular telephone 100 for the user to target one or more webpages. Upon being identified, operations of the web browser 102 may include requesting, via the Internet 202, content from one or more webpage sources 204 a,b,c for the target webpage(s). As illustrated, in this particular example a webpage page is requested from webpage source 204a and a corresponding web asset file or files 206 are sent from the source through the Internet 202 to the cellular telephone 100. In one arrangement, the web asset files 206 include a hypertext markup language (HTML) file that includes instructions for presenting the asset and a cascading style sheet (CSS) file that provides presentation semantics for the asset being provided by the HTML file.

To determine if the web browser 102 is capable of processing and presenting typographical features provided by formats such as OpenType, one or more techniques and methodologies may be implemented. For example, operations may be executed at one or more locations for making the determination. In the illustrated example, operations may be executed by the cellular telephone 100 (or other types of user computing devices) and a font service provider 208, which is in communication with the computing device through one or more networks (e.g., the Internet 202). The font service provider 208 may incorporate one or more architectures, layouts, etc. For example, the font service provider 208 may incorporate a relatively large distributions of systems, computing devices (e.g., servers), etc. deployed in one or more locations (e.g., different geographical locations) and can be considered a content delivery network. Once determined if the web browser supports scalable font formats such as OpenType fonts or not, the font service provider 208 may execute operations to provide appropriate information to the user device for presenting the OpenType fonts for either situation (e.g., the web browser supports OpenType fonts or the web browser does not support OpenType fonts). As illustrated in the figure, a font file 210 represents the font information that is sent from the font service provider 208 to the user device (i.e., the cellular telephone 100). Once the font information (e.g., the font file 210) is received, the information is used by the user device (e.g., executed by an asset presenter such as a web browser) to present the typographical features of the scalable font format such as OpenType fonts. In the illustrated example, a determination is made whether a web browser supports scalable font formats such as OpenType fonts, however such a determination may be made for other types of web asset presenters. For example, along with web browsers, a web asset presenter may be consider as one or more applications (referred to as a web-based application) that can access or be accessed over a network such as the Internet, an intranet, etc. Such web-based applications may also be considered as software applications that are hosted over a network and coded in a browser supported programming language (such as JavaScript, combined with a browser-rendered markup language such as HTML, etc.). A web asset presenter may also be one or more applications (e.g., native application) executed on a computing device (or multiple devices) such as a user device (e.g., the cellular telephone 100) that provide a view of a web asset (e.g., a web view). Similar applications executed locally, remotely, or in combination among multiple locations may be considered as a web asset presenter. Similar to making the determination for web asset presenters, such a determination may be made for asset presenters that do not communicate with networks such as the Internet. For example, an asset presenter may be considered as one or more applications locally executed by a computing device that is capable of presenting network based assets such webpages, websites, etc. without being in communication with the Internet.

One or more architectures may be implemented by the font service provider 208 for determining if a web browser is capable of presenting OpenType fonts along with other functionality. In the illustrated arrangement, a font service manager 212 is executed by a server 214 located at the font service provider 208. To prepare and provide the font file 210 (or files) to the user device, the font service manager 212 may access information from one or more sources such as a storage device 216 (e.g., one or more hard drives, CD-ROMs, etc.) located at the font service provider 208. However, the font information provided by the server 214 may also be collected from one or more other sources located internal or external to the font service provider 208. In one arrangement, upon receiving and executing the web asset file(s) 206 (e.g., the HTML file), the web browser 102 may initiate a request to be delivered to the font service provider 208 that asks for a software agent to be sent to the user device (e.g., the cellular telephone 100). Such agents can be considered as a software module that may be executable in a substantially autonomous manner. For example, upon being provided to the user computer device (e.g., the cellular telephone 100), a software agent may operate without considerable user interaction. By operating in a somewhat flexible manner, the software agent can adaptively identify if the web browser 102 being executed by the user device is capable of supporting scalable font formats such as OpenType fonts and features. In one arrangement, the software agent may be implemented as a file that includes scripting language that is capable of supporting a variety of programming styles (e.g., JavaScript). Once received, the software agent may be executed (e.g., by the web browser 102) to determine if the executed browser 102 is capable of presenting OpenType fonts. To make such a determination, one or more techniques may be implemented. For example, by identifying the browser being executed (e.g., from information such as browser type, version, manufacturer, etc.) the software agent may use one or more predefined rules (e.g., Microsoft Internet Explorer version 10 supports OpenType fonts, Microsoft Internet Explorer version 8 does not support OpenType fonts, etc.) to determine if the web browser is capable of presenting such formatted typographical features. Along with a rules-based determination being used by the software agent to determine if a web browser supports OpenType fonts (or another type of scalable font format), other techniques and methodology may be implemented. For example, the software agent may poll the web browser, test the browser, etc. to determine if the browser supports scalable font formats such as OpenType fonts.

Along with determining whether web browsers are capable of supporting OpenType fonts, the software agent may also gather other information for having typographical features of a target web asset presented by the user computing device. For example, the software agent may identify the particular typographical features that are included in the web asset to which font information is needed from the font service provider 208. In one arrangement, the software agent may scan the CSS file provided with the web asset file(s) 206 of the web asset to determine one or more styles to be applied for presenting typographical elements (referred to as classes) included in the web asset. The software agent may also review the HTML file provided with the web asset file(s) 206 to identify the particular characters, glyphs and other typographical elements (e.g., an “fi” ligature, a single glyph fraction representing the character “A”, etc.) being used by the asset. Once identified, this information may be provided to the font service provider 208 for processing and preparing the needed information for delivery to the user computing device (e.g., the cellular telephone 100) for presenting the content of the asset. For example, provided the information of the web asset, the font service manager 212 may prepare one or more font subsets such that the only font information provided to the user device is the information needed to present the web asset and no addition font information (e.g., font characters not included in the web asset) is transmitted from the font service provider 208 to the user computing device.

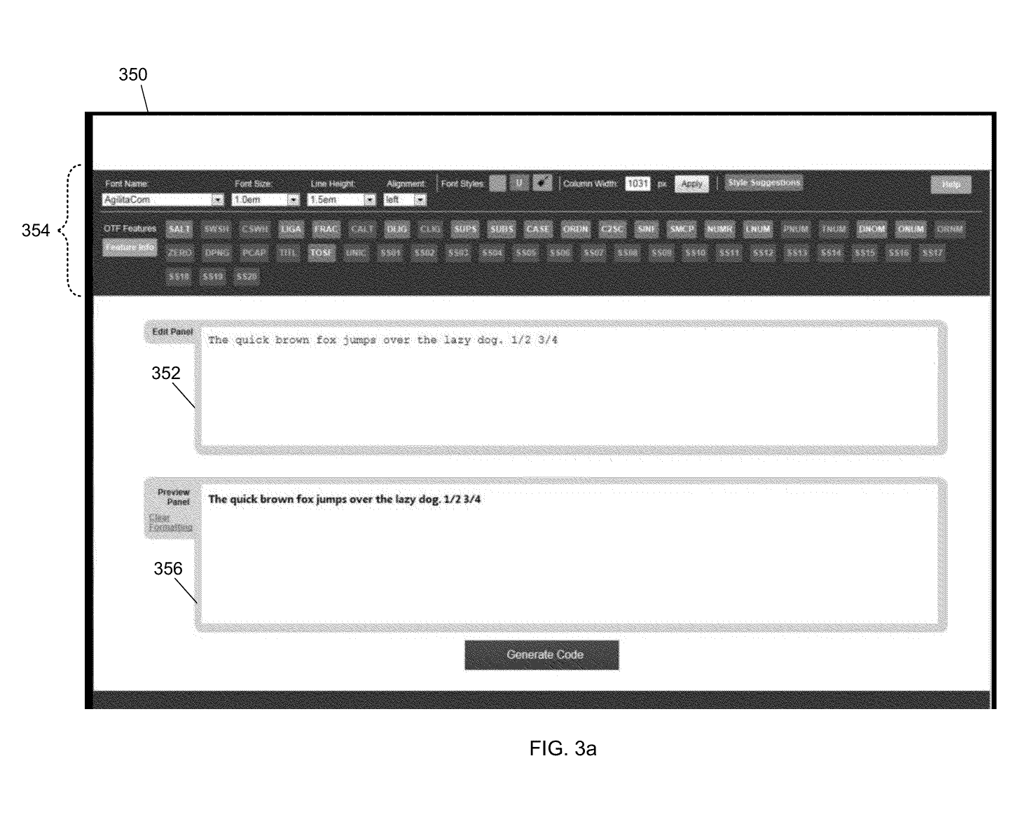

Referring to FIG. 3, a diagram 300 graphically illustrates data transfers such that appropriate information is provided to asset presenters (e.g., web browsers) for presenting web assets based upon whether or not the asset presenter supports scalable font formats such as OpenType. In this illustration, one computing device (i.e., the cellular telephone 100) does not support this capability and another computing device (i.e., a tablet computing device 302) is capable of presenting such formatted scalable fonts. Both devices respectively execute browsers 102, 304, which in this example, are directed to the same target web asset. From the source of the web asset, the corresponding web asset file(s) 206 are provided to each device 100, 302. Upon receiving the file(s), software agents 306, 308 are respectively provided to the devices (e.g., from the font service provider 208) and are executed to determine if each corresponding device is capable of supporting, for example, OpenType fonts. To initiate the delivery of the software agents 306, 308, one or more techniques may be implemented. For example, once delivered the web asset file(s) 206 (e.g., an HTML file and a CSS file) may be used (e.g., executed) by the recipient device to initiate a request being sent to the font service provider 208. Receiving the request, a software agent (e.g., a JavaScript file) may be sent as a reply from the font service manager 212 being executed by the server 214 at the font service provider 208. Along with sending the software agent, the font service provider 208 may perform other operations associated with the software agent. For example, at predefined times (e.g., intervals, event triggered times, etc.) the agent may be updated by the font service provider 208 as information is collected. Information regarding which types of browsers is capable of supporting OpenType fonts, incapable of supporting OpenType fonts, etc. may be gathered and included in updated versions of the software agent. The font service manager 212 may execute other operations in some arrangements. For example, the font service manager 212 may determine if a web browser is capable of supporting or not supporting scalable font formats such as OpenType and corresponding features. Receiving information from a device (e.g., the type of browser being executed by the device in a request such as request 310), the font service manager 212 may be able to determine if scalable font formats are supported by the device and execute appropriate operations.

Along with determining if a browser is capable of supporting scalable font formats such as OpenType fonts, the software agents 306, 308 may be capable of performing other operations. For example, operations may be respectively executed by the software agents 306, 308 to collect information regarding the typographical features and content of the web asset being provided by the web asset file(s) 206. In one example, each software agent reads a CSS file included with the web asset file(s) 206 to identify which font classes may be used by the asset. The software agent may also read the HTML file included with the web asset file(s) 206 to identify the particular characters that may be used by the web asset. In some arrangements, the software agent may read information of the HTML file from other sources, for example, information from a document object model (DOM) or a node-based structure used to organize the information (e.g., a DOM tree). By identifying data such as the classes and characters used by the web asset, one or more advantageous operations may be executed. For example, if a relatively small number of characters, glyphs, etc. for a particular font class are identified as being presented for the web asset, a font character subset that only includes those identified characters, glyphs, etc. may be provided by the font service provider 208, thereby conserving processing time and memory by not having font characters absent from the web asset being sent to the corresponding user device. Similar to identifying the characters, glyphs, etc., typographical features in scalable font formats (e.g., OpenType features such as ligatures, single character fractions, etc.) may be identified by the software agent and provided to the font service provider 208 for preparing and providing appropriate subsets of the features. Incremental subsetting techniques may also be employed. For example, after a subset is produced for the characters, typographical features, etc. present in a first page of a web asset, these identified characters may not be included in subset(s) for subsequent pages (e.g., a second page) of the web asset. By filtering out characters, typographical features, etc. already present in a subset, less processing time and memory may be consumed in a redundant manner.

In some arrangements, operations of the software agents 306, 308 may be initiated by one or more conditions being satisfied, one or more events occurring, etc. For example, the software agents may not use the contents of the web asset file(s) 206 until appropriately signaled that one or more events have occurred. In one arrangement, applications such as a text-to-speech application may process the contents of the web asset file(s) 206 prior to being used by the software agents 306, 308. For example, once textual content of the web asset file(s) 206 (e.g., an HTML file) has been read by the text-to-speech application (e.g., for conversion to audible speech), one or more signals may be sent (or other type of signaling technique employed) to notify the software agents 306, 308 that the web asset files(s) 206 may be accessed and used.

To provide the collected information (e.g., does the browser support OpenType fonts, what font classes are included in the web asset, etc.) one or more techniques or methodologies may be implemented. For example, to provide the collected information to the font service provider 208, each of the user devices 100, 300 may send a corresponding request 310, 312 to the font service provider. In this arrangement, each device is wirelessly connected to the one or more networks (e.g., the Internet) for exchanging information with the font service provider 208, as represented with the respective graphics 314, 316. Upon receiving the requests 310, 312, the font service manager 212 prepares font information for the devices based upon the information provided in each respective request. For example, dependent upon the capability of the corresponding browser, different types of information may be respectively prepared and sent by the font service provider 208. In the illustrated arrangement, a font file 318 is prepared and sent to the device 302 executing the web browser 304 that assists the device in supporting OpenType fonts. In general, the information included in the font file 318 allows the device 302 to present the typographical content of the web asset as authored (e.g., using OpenType fonts). In one arrangement, the font file 318 may include one or more tables for mapping information that identifies a character (e.g., represented by a character code) and the particular glyph to be presented (e.g., represented by a glyph index). For example, a character to glyph index mapping table (cmap) may be provided that maps between character codes and glyph indices. In some arrangements the font file 318 may include one or more tables that include information for substituting glyphs such as a glyph substitution table (GSUB), for example, to allow one or more glyph indices of a cmap table to be mapped to one or more indices representing glyph substitutes.

Some web browsers may only be able to support fonts that are absent scalable font format features such as OpenType font features. As such, a character code may not be assigned to the feature (e.g., a ligature) while a glyph index has been assigned to the feature (e.g., the font includes a glyph shape for an OpenType font feature but a character code has not been assigned to the feature). As such, an appropriate mapping table (a cmap table) may not include character codes for the needed OpenType features. In this example, recognizing that the web browser 102 of the device 100 does not support scalable font formats (e.g., from the information provided by the request 312), different font information may be sent to the user device (compared to the font file 318 sent to the user device 302 capable of supporting such fonts). One or more techniques may be implemented to provide font information to non-supporting web browsers for presenting features of scalable font formats such as OpenType fonts. In the illustrated example, based upon the information included in the request 312, multiple files are sent from the font service provider 208 to the non-supporting browser 102 of user device 100. In particular, a font file 320 is delivered from the font service provider 208 that includes font information needed to present the content of the web asset. The font file 320 can be considered a modified font file (compared to the font file 318) and may be absent the one or more tables provided in the font file 318 (e.g., a GSUB table). Portions of one or more tables may also be removed similar to removing an entire table or tables. For example, determining the particular features included in the web asset, only the scalable font format features such as OpenType features identified in the web asset may be included in the font file 320. By sending the needed subset of OpenType features, memory may be conserved along with processing time and throughput (and/or other transmission characteristics). Similar subsetting may also be executed for the font file provided to a browser that supports scalable font formats (such as the font file 318 provided to the browser 304). As such, memory, processing time, throughput etc. may be conserved by providing the subset of OpenType features (or features of other scalable font formats) identified as being included in the web asset and not providing the features absent from the web asset.

Since the font file 320 is being provided to a non-supporting browser, information is typically included in the file to assist with the web browser with presenting content using the features of scalable font formats. For example, the character codes included in the font file 320 may be modified (compared to the character codes of font file 318) by having one or more additional character codes added for OpenType features used in the web asset (e.g., a ligature, a single character fraction, etc.). In one arrangement, previously unused character codes (referred to as private codes) may be assigned to OpenType font features such that the codes can be used for presenting font features of the web asset by a non-supporting web browser (e.g., private codes may be added a cmap table). Various techniques may be implemented to provide the OpenType features in one file (e.g., the font file 320) or more files. While all of the OpenType features may be provided in some instances, a subset of the features may be provided in some arrangements (e.g., based upon the information provided by a request such as the request 312). For example, multiple files may be used for delivering a complete OpenType feature set or the appropriate subset of OpenType features. In some arrangements each subsetted OpenType feature may be delivered in an individual file or the features may be concatenated together into a single file.

In addition to the font file 320, an executable file 322 may be provided by the font service provider 208. Typically, the executable file 322 (e.g., a JavaScript file) includes logic for mapping character codes to glyphs for presenting the typographical content of the web asset. In some arrangements, the executable file 322 includes logic for inserting appropriate glyphs. For example, the executable file 322 may include a rule for inserting an OpenType font feature (e.g., a single character fraction such as “½”) when one or more conditions occur (e.g., detecting an integer such as “1” followed by a slanted line “/” and then by another integer such as “2”). In some arrangements satisfied conditions of detected instances for inserting such features may be implemented by using one or more other techniques individually or in combination. For example, as content of the web asset is scanned (e.g., by scanning a DOM tree, an HTML file, etc.), the scanned characters may be used to determine if one or more predefined executable operations (e.g., methods, functions, etc.) are present. In some architectures determining if a particular executable operation exists may be more computationally efficient than comparing scanned characters to a collection of rules. For example, as characters are scanned (e.g., the character “f” is scanned followed by the character “i”), a relatively quick determination may be made if an operation (e.g., method, function, etc.) exists that uses the scanned character in the name of the operation (e.g., a method entitled “f and i ligature insertion method”). If the scanned characters are used and the operation does exist, then the operation (or operations) may then be executed. If determined that such an operation for the scanned characters does not exist, the next scanned characters (e.g., the next sequential group of scanned characters) may be used to determine if a corresponding operation (e.g., method, function, etc.) exists for those characters.

One or more techniques may be implemented for inserting such features. For example, data (e.g., a private character code) may be inserted into a DOM tree of a web asset at runtime to represent the OpenType font feature to be used. From the logic provided by the executable file 322, and the modified font information (e.g., including additional character codes for OpenType font features) of the font file 320, the non-supporting web browser 102 can become capable of supporting such font features (e.g., OpenType font features) of web assets presented by the user device 100. Similar to the font files 320, 318, the contents of the executable file 322 may be reduced based upon the subset of material included in the web asset. For example, logic (e.g., one or more rules for OpenType font feature) may be absent from the executable file 322 if corresponding features are not included in the content of the web asset (e.g., remove ligature rules if the asset includes no ligatures). Further, multiple executable files may be sent from the font service provider 208 to the device rather than a single executable file. For example, multiple files may be used for delivering the logic for a complete OpenType feature set or the appropriate subset of OpenType features. In some arrangements each subsetted OpenType feature may be delivered in an individual file or the features may be concatenated together into a single file. Along with using the information provided from the font service provider 208 for presenting features such as OpenType font features (e.g., with asset presenters that support or do not support such features), the information (e.g., provided by one or more font files, executable files, etc.) may be used for other applications. For example, this information may be utilized by an editor, executed locally (e.g., by a user device) or remotely (e.g., at the font service provider or other location), for corresponding applications (e.g., creating content, editing content, managing content, etc.). Referring to FIG. 3a, a user interface 350 is presented that includes an editor that allows a user to select various types of characters (e.g., to create different types of presentations, assets, applications, etc.). Similar to providing characters for selection, the user interface 350 also provides glyphs, fonts, typographical features etc. for content creation. For example, features of scalable font formats such as OpenType font features may be presented for selection and use in creating content. As shown in the figure, the user interface 350 includes an edit pane 352 for a user to input content (e.g., characters selected from a keyboard). The user interface also includes a region 354 populated with selectable icons (e.g., buttons) that represent various features such as OpenType features that may be selected for applying a corresponding feature to the input content (e.g., a single character fraction by selecting the “FRAC” icon). The user interface also includes a preview pane 356 that allows the user to view the applied features. Along with different variants of such editors, other types of user interfaces may be implemented. For example, interfaces may be implemented that are directed toward use on a local computer. Similarly, interfaces may be implemented for use by remotely located computer systems (e.g., for cloud-based computer systems and services) and other types of computer and network architectures.

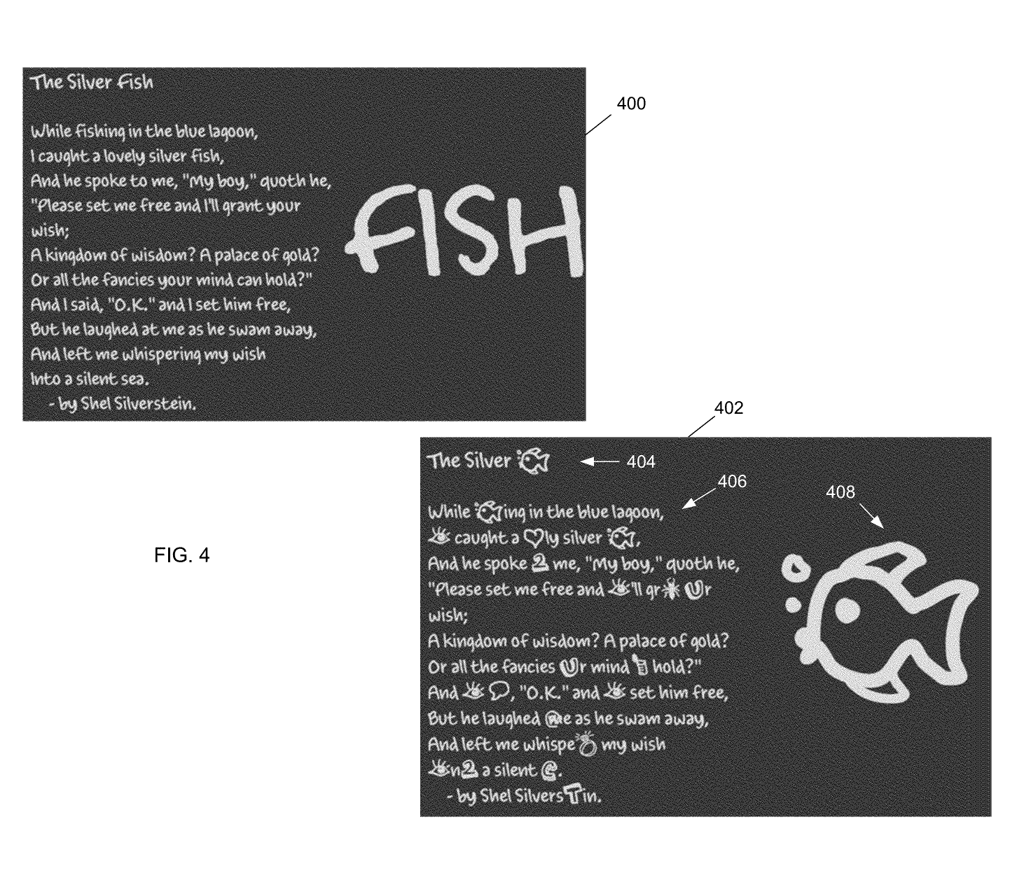

Referring to FIG. 4, a graphical representation 400 is presented that includes typographical content of a web asset (e.g., as provided by the web asset file(s) 206) that is absent OpenType font features. For example, the text presented by the representation 400 correlates to the content of the web asset being presented by a web browser (e.g., browser 102) that does not support scalable font formats such as OpenType fonts. Another graphical representation 402 is also presented that includes graphical alternatives as provided by an OpenType font feature.

Along with the term “I” being replaced by the contextual alternative “ [symbol] ”, other characters and terms are replaced by other contextual alternatives. For example, the term “you” is replaced by an outlined version of the character “U” and the term “to” is replaced by outlined version of the integer “2”. Other imagery is also used for replacing other terms, for example, each instance of the term “fish” is replaced by a graphical image of a fish. Similarly, the term “can” is replaced by a graphical representation of an opened can and the term “ring” is replaced by a graphical image of a diamond ring. Along with being more likely to grab the attention of a would-be viewer, such OpenType font features may improve the viewing experience and may even entice viewers into expanding their viewing period of the web asset.

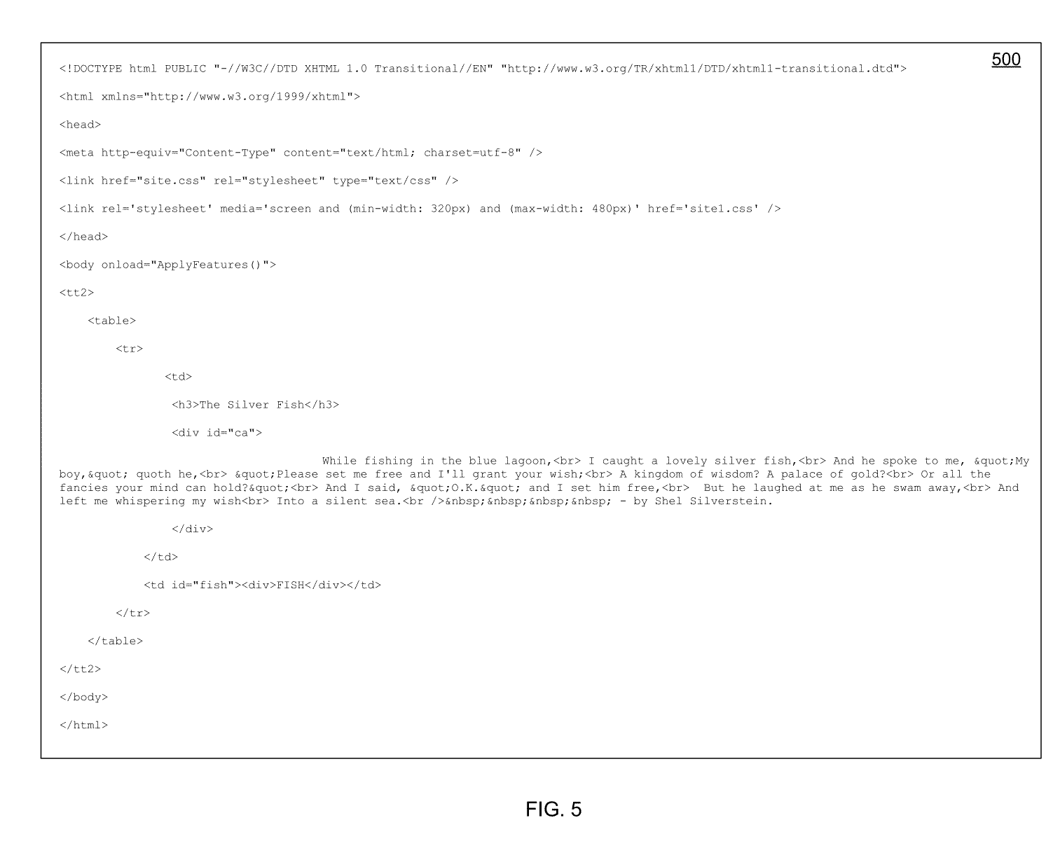

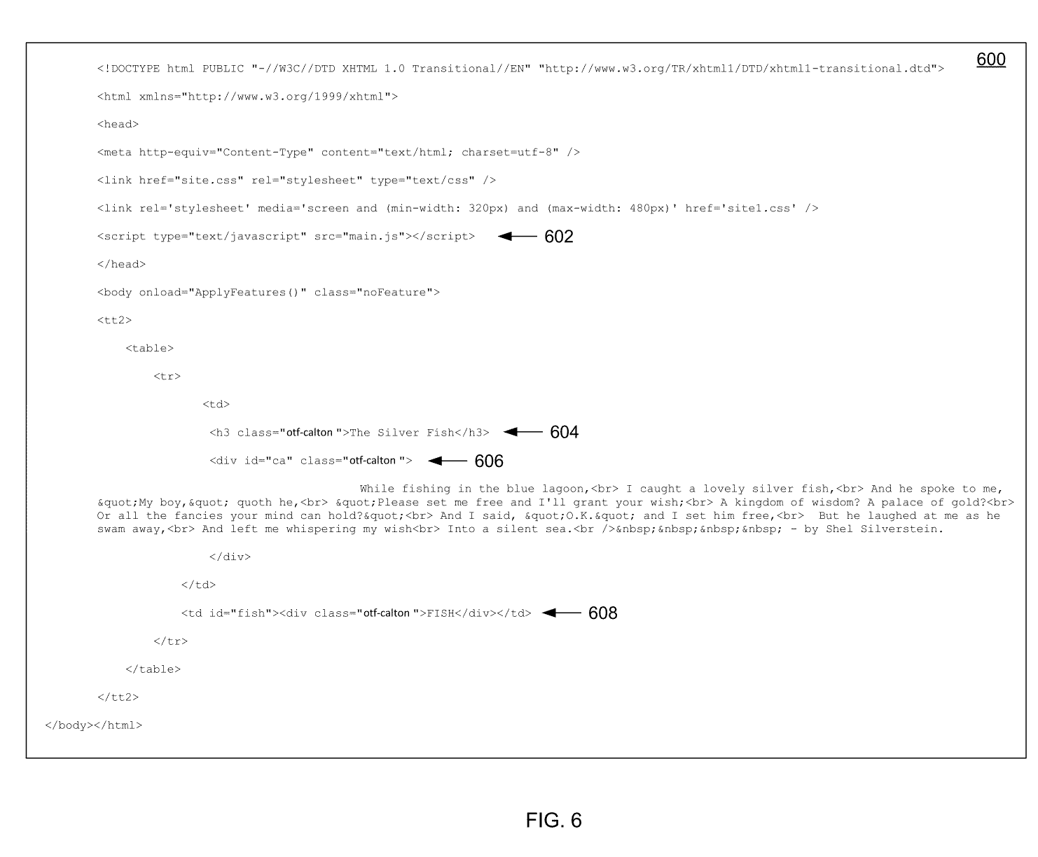

Referring to FIG. 5, an HTML file 500 is presented that includes instructions for producing the web asset presented in the graphical representation 400 (shown in FIG. 4) that is absent OpenType font features (e.g., contextual alternatives). Along with providing the text for presentation and corresponding instructions, the file also identifies the CSS file that provides stylistic information for presenting the asset. To provide the OpenType font features (e.g., contextual alternatives), one or more adjustments may be made to the HTML file 500. For example, referring to FIG. 6 another HTML file 600 is presented, which is an adjusted version of the HTML file 500 (shown in FIG. 5), and includes instructions and information such that OpenType font features are included in the graphical presentation provided by the executed file. For example, an instruction 602 has been included on the HTML file to provide a path to a server (e.g., the server 214) of the font service provider 208 for file retrieval. In this arrangement, the instruction 602 also identifies a JavaScript file (i.e., titled “otfmain.js”), which when executed initiates the requesting for a software agent (e.g., the software agent 306) to be provided by the font service provider 208. In this particular example, a class name (e.g., a four byte name) is defined for each of each feature that may be exploited by the HTML file. Contextual alternatives may be identified with “calt”, ligatures by “liga”, discretionary ligatures by “dlig”, swashes by “swsh”, one character fractions as “frac”, etc. Additionally, information regarding these OpenType features may be placed in the CSS file. For example, the features may be added as style elements to the CSS file.

In the HTLM file 600 presented in the figure, the contextual alternative class (labeled “otf-calton”) is inserted into the file to indicate portions of the presented asset that may incorporate contextual alternatives. In this particular example, the OpenType feature class for contextual alternatives is inserted with an instruction 604 for a main header of the asset (indicated with an arrow 404 in FIG. 4). Additionally, contextual alternatives are included in the main text of the web asset as provided by the instruction 606 (and indicated with an arrow 406 in FIG. 4) and also included for the text presented in the right side of the representation 402 as provided by the instruction 608 (and indicated with an arrow 408 in FIG. 4). By including these instructions, the software agent can determine which OpenType feature classes are being used for producing the web asset (e.g., for example by scanning the HTML file and CSS file of the web asset) and accordingly requesting the classes from the font service provider 208. Further, by identifying the particular contextual alternatives (e.g., the “ [symbol] ” character to replace the “I” character) included in the web asset as provided by the HTML file, appropriate information may be requested from the font service provider.

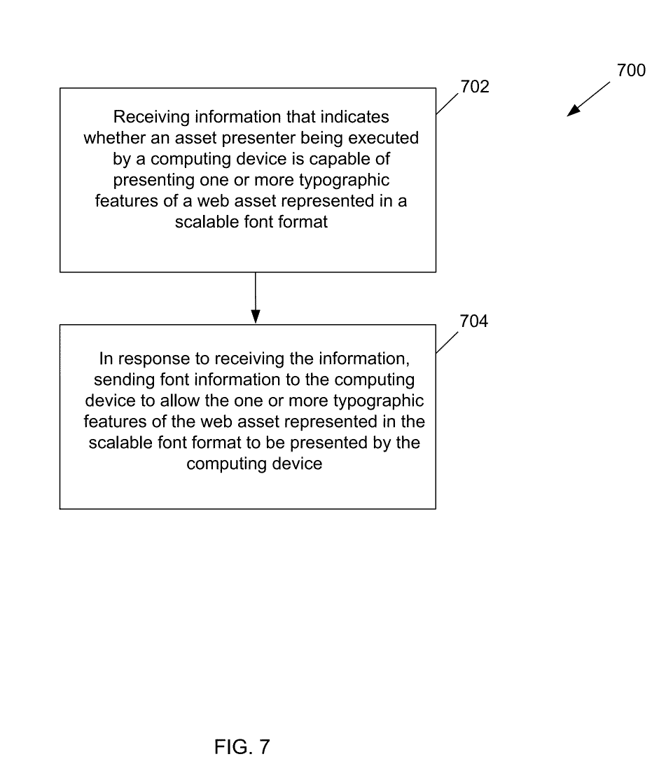

Referring to FIG. 7, a flowchart 700 represents operations of a font service manager (e.g., the font service manager 212 shown in FIG. 2). Operations of the font service manager are typically executed by a single computing device (e.g., the server 214 also shown in FIG. 3); however, operations of the font service manager may be executed by multiple computing devices. Along with being executed at a single site (e.g., the font service provider 208 shown in FIG. 3), operation execution may be distributed among two or more locations.

Operations of the font service manager may include receiving 702 information that indicates whether an asset presenter (e.g., a web browser) being executed by a computing device is capable of presenting one or more typographic features of a web asset represented in a scalable font format. For example, a request may be sent from the computing device to the font service provider (where the font service manager is executed) that contains information indicative of whether a web browser executed by the device supports OpenType font features. Operations may also include, in response to receiving the information, sending 704 font information to the computing device to allow the one or more typographic features of the web asset represented in the scalable font format to be presented by the computing device. For example, a font file may be sent by the font service provider that includes modified information (e.g., including additional character codes) along with an executable file (e.g., a JavaScript file) that includes logic (e.g., rules) for using the character codes provided by the font file. Other operations may also subset the font information prior to sending the information to the computing device.

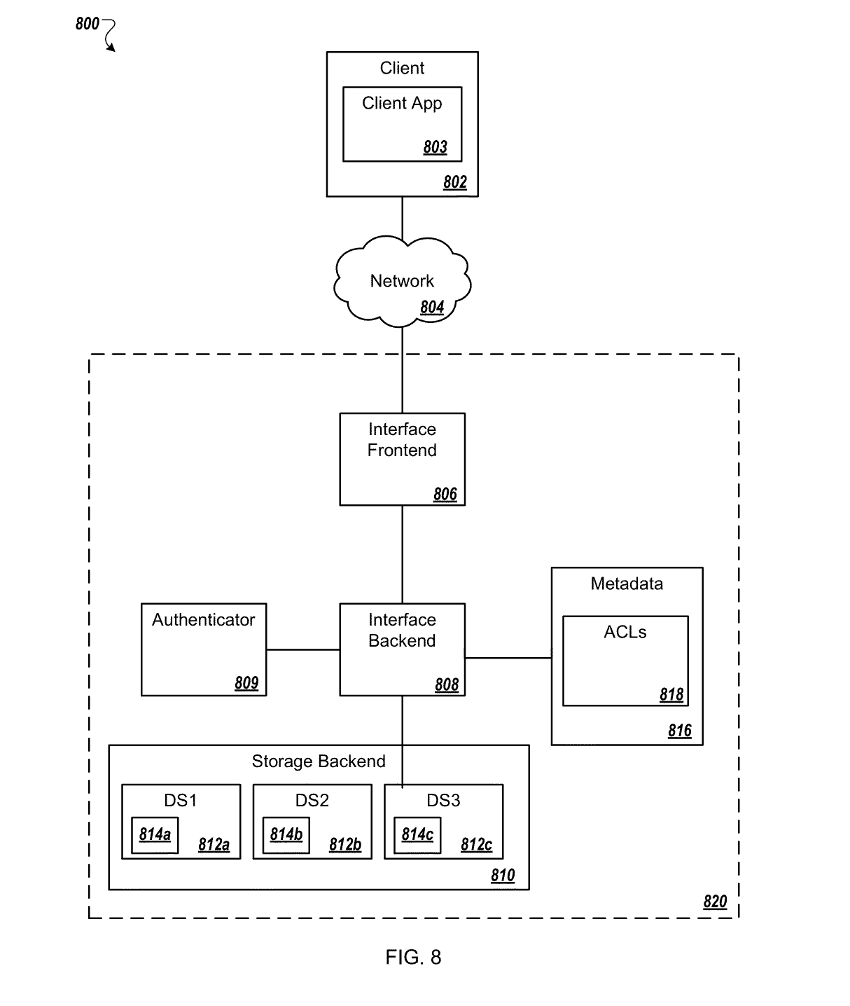

FIG. 8 is a block diagram showing an example of a system 800 for providing hosted storage and accessing the hosted storage from a client device 802. In some implementations, a hosted storage service 820 may provide access to stored data (e.g., font information) by applications (e.g., web browsers) running on computing devices operating separately from one another, provide offsite data backup and restore functionality, provide data storage to a computing device with limited storage capabilities, and/or provide storage functionality not implemented on a computing device.

The system 800 may provide scalable stores for storing data resources. The client device 802 may upload data resources to the hosted storage service 820 and control access to the uploaded data resources. Access control may include a range of sharing levels (e.g., private, shared with one or more individuals, shared with one or more groups, public, etc.). Data stored in hosted storage service 820 can be secured from unauthorized access. The hosted storage service 820 can use a simple and consistent application programming interface, or API, which can allow arbitrary quantities of structured or unstructured data to be kept private or shared between individuals, organizations, or with the world at large. The client device 802 may access, retrieve, be provided, store, etc. data in the hosted storage service 820 for any number of a variety of reasons. For example, data may be stored for business reasons (e.g., provide identification information to attain access clearance for font data at the hosted storage service 820), or for use in data processing by other services.

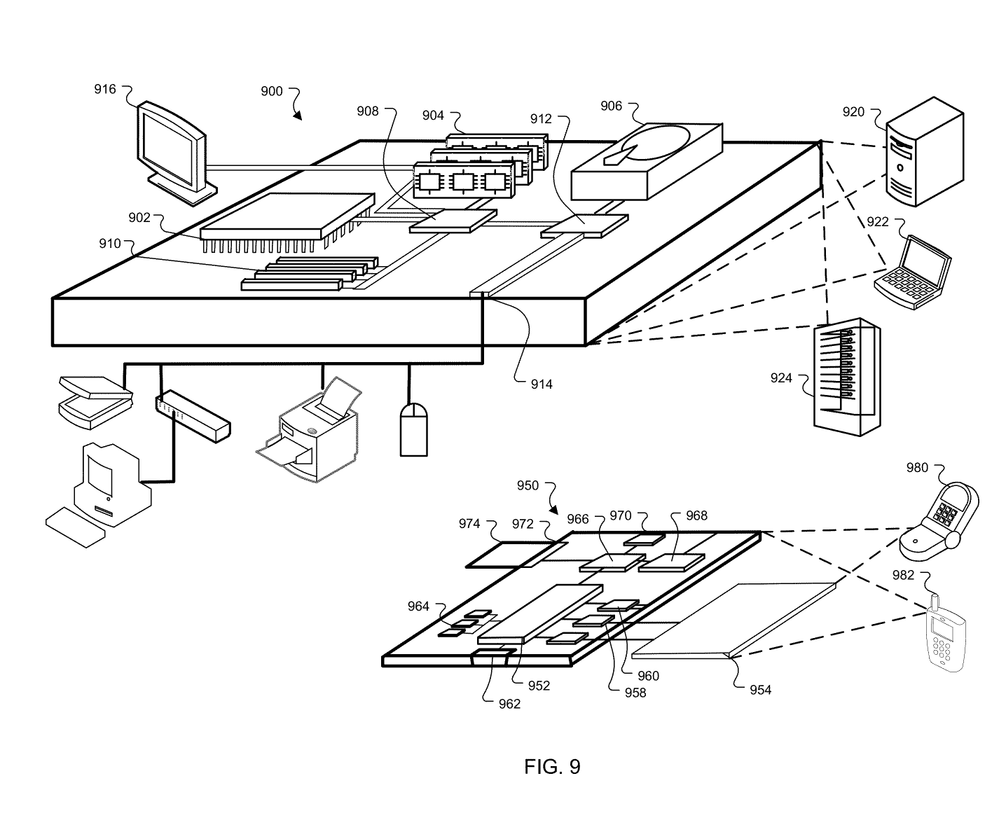

The client device 802 may be implemented using a computing device, such as the computing device 900 or the mobile device 950 described with respect to FIG. 9. The client device 802 may communicate with the hosted storage service 820 via a network 804, such as the Internet. The client device 802 may communicate across the network using communication protocols such as, for example, one or more of Transmission Control Protocol/Internet Protocol (TCP/IP), Hypertext Transfer Protocol (HTTP), Secure Shell Remote Protocol (SSH), or Application Program Interfaces (API). While only a single client device 802 is shown, there may be multiple client devices communicating across the network 804 with the hosted storage service 820 and/or other services and devices.

The hosted storage service 820 may be implemented such that client applications executing on client device 802, such as a client application 803, may store, retrieve, or otherwise manipulate data resources in the hosted storage service 820. The hosted storage service 820 may be implemented by one or more server devices, which may be implemented using a computing device, such as the computing device 900 or mobile device 950 described with respect to FIG. 9. For example, the hosted storage service 820 may be implemented by multiple server devices operating in the same, or different, data centers.

The hosted storage service 820 generally includes an interface frontend 806, an interface backend 808, a storage backend 810, and metadata 816 for resources stored in the storage backend 810. The hosted storage service 820 may also include an authenticator 809 to verify that a user requesting one or more fonts should be provided access to the fonts (e.g., based on a service subscription, rental period, etc.).

In general, the interface frontend 806 may receive requests from and send responses to the client device 802. For instance, the hosted storage service 820 may be implemented as a Web Service with a corresponding set of Web Service Application Programming Interfaces (APIs). The Web Service APIs may be implemented, for example, as a Representational State Transfer (REST)-based HTTP interface or a Simple Object Access Protocol (SOAP)-based interface. Interface frontend 806 may receive messages from the client 802 and parse the requests into a format usable by the hosted storage service 820, such as a remote procedure call (RPC) to an interface backend 808. The interface frontend 806 may write responses generated by the hosted storage service 820 for transmission to the client 802. In some implementations, multiple interface frontends 806 may be implemented, for example to support multiple access protocols.

The interface frontend 806 may include a graphical front end, for example to display on a web browser for data access. The interface frontend 806 may include a sub-system to enable managed uploads and downloads of large files (e.g., for functionality such as pause, resume, and recover from time-out). The interface frontend 806 may monitor load information and update logs, for example to track and protect against denial of service (DOS) attacks.

As described above, the Web Service API may be a REST-based HTTP interface. In a REST-based interface, a data resource is accessed as a resource, uniquely named using a uniform resource identifier (URI), and the client application 803 and service 820 exchange representations of resource state using a defined set of operations. For example, requested actions may be represented as verbs, such as by HTTP GET, PUT, POST, HEAD, and DELETE verbs. The GET verb may be used to retrieve a resource, while the HEAD verb may be used to retrieve information about a resource without retrieving the resource itself. The DELETE verb may be used to delete a resource from the hosted storage service 820. The PUT and POST verbs may be used to upload a resource to the service 820. PUT requests may come from the client 802 and contain authentication and authorization credentials and resource metadata in a header, such as an HTTP header. POST requests may be received when a client 802 wants to upload from a web browser form. The form POST upload protocol for the hosted storage service 820 may involve multiple form fields to provide authentication, authorization, and resource metadata. More generally, any of the API requests may include credentials for authentication and authorization, for example in a header of the request. An authorization header may be included in the REST requests, which may include an access key to identify the entity sending the request.

Alternatively, or additionally, a user may be authenticated based on credentials stored in a browser cookie, which may be appended to the API requests. If no valid cookie is present, a redirect to an authentication frontend may be generated, and the authentication frontend may be used to generate the browser cookie. The authentication frontend may be used by systems and services in addition to the hosted storage service 820 (e.g., if the organization operating the hosted storage service 820 also operates other web services such as email service). A user may also or alternatively be authenticated based on authentication credentials from an external credentialing service or an external service that includes credentialing functionality. User or group identifier information may be calculated from the external service's credential information. Requests sent by the client 802 to the interface frontend 806 may be translated and forwarded to the external service for authentication.

In general, resources stored in the hosted storage service 820 may be referenced by resource identifiers. The hosted storage service 820 may define namespaces to which a valid resource identifier must conform. For example, the namespace may require that resource identifiers be a sequence of Unicode characters whose UTF-8 encoding is at most 1024 bytes long. As another example, the namespace may require that resource identifiers be globally unique identifiers (GUIDs), which may be 128-bit integers.

Resources (e.g., objects such as font data) may be stored in hosted storage service 820 in buckets. In some examples, each bucket is uniquely named in the hosted storage service 820, each data resource is uniquely named in a bucket, and every bucket and data resource combination is unique. Data resources may be uniquely identified by a URI that includes the bucket name and the resource name, and identifies the hosted storage service 820. For example, a resource named “long/song.mp3” in a bucket named “music” could be specified using a URI pattern such as http://s.hostedstoragesystem.com/music/long/song.mp3 or http://music.s.hostedstoragesystem.com/long/song.mp3. Alternatively, the user of the client 802 may create a bucket named my.music.org, publish a CNAME alias redirected to http://music.s.hostedstoragesystem.com, and address the resource as http://my.music.org/long/song.mp3. In some examples, buckets do not nest.

The interface backend 808 along with the authenticator 809 may handle request authentication and authorization, may manage data and metadata, and may track activity such as for billing. As one example, the interface backend 808 may query the authenticator 809 when a request for one or more fonts is received. The interface backend 808 may also provide additional or alternative functionality. For example, the interface backend 808 may provide functionality for independent frontend/backend scaling for resource utilization and responsiveness under localized heavy loads. Data management may be encapsulated in the interface backend 808 while communication serving may be encapsulated in the interface frontend 806. The interface backend 808 may isolate certain security mechanisms from the client-facing interface frontend 806.

The interface backend 808 may expose an interface usable by both the interface frontend 806 and other systems. In some examples, some features of the interface backend 808 are accessible only by an interface frontend (not shown) used by the owners of the hosted storage service 820 (internal users). Such features may include those needed for administrative tasks (e.g., resolving a resource reference to a low level disk address). The interface backend 808 may handle request authentication (e.g., ensuring a user's credentials are valid) and authorization (e.g., verifying that a requested operation is permitted). The interface backend may also provide encryption and decryption services to prevent unauthorized access to data, even by internal users.

The interface backend 808 may manage metadata 816 associated with data resources, for example in a MySQL database or BigTable. User-specified names labeling the buckets can be completely defined within the metadata 816, and resource metadata 816 can map a resource name to one or more datastores 812 storing the resource. The metadata 816 can also contain bucket and resource creation times, resource sizes, hashes, and access control lists 818 (ACL 818) for both buckets and resources. The interface backend 808 can log activity and track storage consumption to support accounting for billing and chargebacks. In some examples, this includes quota monitoring in each dimension in which customers are charged (e.g., reads, writes, network transfers, total storage in use).

The ACLs 818 may generally define who is authorized to perform actions on corresponding buckets or resources, and the nature of the permitted actions. The ACLs 818 may be an unordered list of {scope, role} pairs, plus Boolean flags. The scope may define a user or group of users and the role may define the access permissions for the user or group. In some examples, the union of all {scope, role} pairs may define access rights. In some examples, more specific {scope, role} pairs override more general ones.

The storage backend 810 may contain multiple datastores 812a-812c. Although three datastores 812 are shown, more or fewer are possible. Each of the datastores 812a-812c may store data resources 814a-814c in a particular format. For example, data store 812a may store a data resource 814a as a Binary Large Object (BLOB), data store 812b may store a data resource 814b in a distributed file system (e.g., Network File System), and data store 812c may store a data resource 814c in a database (e.g., MySQL).

FIG. 9 shows an example of example computer device 900 and example mobile computer device 950, which can be used to implement the techniques described herein. For example, a portion or all of the operations of the font service manager 212 (shown in FIG. 2) may be executed by the computer device 900 and/or the mobile computer device 950. Computing device 900 is intended to represent various forms of digital computers, including, e.g., laptops, desktops, workstations, personal digital assistants, servers, blade servers, mainframes, and other appropriate computers. Computing device 950 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 900 includes processor 902, memory 904, storage device 906, high-speed interface 908 connecting to memory 904 and high-speed expansion ports 910, and low speed interface 912 connecting to low speed bus 914 and storage device 906. Each of components 902, 904, 906, 908, 910, and 912, are interconnected using various busses, and can be mounted on a common motherboard or in other manners as appropriate. Processor 902 can process instructions for execution within computing device 900, including instructions stored in memory 904 or on storage device 906 to display graphical data for a GUI on an external input/output device, including, e.g., display 916 coupled to high speed interface 908. In other implementations, multiple processors and/or multiple buses can be used, as appropriate, along with multiple memories and types of memory. Also, multiple computing devices 900 can be connected, with each device providing portions of the necessary operations (e.g., as a server bank, a group of blade servers, or a multi-processor system).

Memory 904 stores data within computing device 900. In one implementation, memory 904 is a volatile memory unit or units. In another implementation, memory 904 is a non-volatile memory unit or units. Memory 904 also can be another form of computer-readable medium, including, e.g., a magnetic or optical disk.

Storage device 906 is capable of providing mass storage for computing device 900. In one implementation, storage device 906 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 904, storage device 906, memory on processor 902, and the like.

High-speed controller 908 manages bandwidth-intensive operations for computing device 900, while low speed controller 912 manages lower bandwidth-intensive operations. Such allocation of functions is an example only. In one implementation, high-speed controller 908 is coupled to memory 904, display 916 (e.g., through a graphics processor or accelerator), and to high-speed expansion ports 910, which can accept various expansion cards (not shown). In the implementation, low-speed controller 912 is coupled to storage device 906 and low-speed expansion port 914. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 900 can be implemented in a number of different forms, as shown in the figure. For example, it can be implemented as standard server 920, or multiple times in a group of such servers. It also can be implemented as part of rack server system 924. In addition or as an alternative, it can be implemented in a personal computer including, e.g., laptop computer 922. In some examples, components from computing device 900 can be combined with other components in a mobile device (not shown), including, e.g., device 950. Each of such devices can contain one or more of computing device 900, 950, and an entire system can be made up of multiple computing devices 900, 950 communicating with each other.

Computing device 950 includes processor 952, memory 964, an input/output device including, e.g., display 954, communication interface 966, and transceiver 968, among other components. Device 950 also can be provided with a storage device, including, e.g., a microdrive or other device, to provide additional storage. Each of components 950, 952, 964, 954, 966, and 968, are interconnected using various buses, and several of the components can be mounted on a common motherboard or in other manners as appropriate.

Processor 952 can execute instructions within computing device 950, including instructions stored in memory 964. The processor can be implemented as a chipset of chips that include separate and multiple analog and digital processors. The processor can provide, for example, for coordination of the other components of device 950, including, e.g., control of user interfaces, applications run by device 950, and wireless communication by device 950.

Processor 952 can communicate with a user through control interface 958 and display interface 956 coupled to display 954. Display 954 can be, for example, a TFT LCD (Thin-Film-Transistor Liquid Crystal Display) or an OLED (Organic Light Emitting Diode) display, or other appropriate display technology. Display interface 956 can comprise appropriate circuitry for driving display 954 to present graphical and other data to a user. Control interface 958 can receive commands from a user and convert them for submission to processor 952. In addition, external interface 962 can communicate with processor 942, so as to enable near area communication of device 950 with other devices. External interface 962 can provide, for example, for wired communication in some implementations, or for wireless communication in other implementations, and multiple interfaces also can be used.

Memory 964 stores data within computing device 950. Memory 964 can be implemented as one or more of a computer-readable medium or media, a volatile memory unit or units, or a non-volatile memory unit or units. Expansion memory 974 also can be provided and connected to device 950 through expansion interface 972, which can include, for example, a SIMM (Single In Line Memory Module) card interface. Such expansion memory 974 can provide extra storage space for device 950, or also can store applications or other data for device 950. Specifically, expansion memory 974 can include instructions to carry out or supplement the processes described above, and can include secure data also. Thus, for example, expansion memory 974 can be provided as a security module for device 950, and can be programmed with instructions that permit secure use of device 950. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 964, expansion memory 974, and/or memory on processor 952, which can be received, for example, over transceiver 968 or external interface 962.

Device 950 can communicate wirelessly through communication interface 966, which can include digital signal processing circuitry where necessary. Communication interface 966 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 968. In addition, short-range communication can occur, including, e.g., using a Bluetooth®, WiFi, or other such transceiver (not shown). In addition, GPS (Global Positioning System) receiver module 970 can provide additional navigation- and location-related wireless data to device 950, which can be used as appropriate by applications running on device 950. Sensors and modules such as cameras, microphones, compasses, accelerators (for orientation sensing), etc. maybe included in the device.

Device 950 also can communicate audibly using audio codec 960, which can receive spoken data from a user and convert it to usable digital data. Audio codec 960 can likewise generate audible sound for a user, including, e.g., through a speaker, e.g., in a handset of device 950. Such sound can include sound from voice telephone calls, can include recorded sound (e.g., voice messages, music files, and the like) and also can include sound generated by applications operating on device 950.

Computing device 950 can be implemented in a number of different forms, as shown in the figure. For example, it can be implemented as cellular telephone 980. It also can be implemented as part of smartphone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A computer-implemented method comprising:
receiving information that indicates whether an asset presenter being executed by a computing device is capable of presenting one or more typographic features of a web asset represented in a scalable font format; and
in response to receiving the information, sending font information to the computing device to allow the one or more typographic features of the web asset represented in the scalable font format to be presented by the computing device.

2. The computer-implemented method of claim 1, wherein sending font information includes sending a font file to the computing device.

3. The computer-implemented method of claim 1, wherein sending font information includes modifying a font file prior to sending the font file to the computing device.

4. The computer-implemented method of claim 3, wherein modifying the font file includes adding one or more character codes to the font file for accessing corresponding glyph shapes.

5. The computer-implemented method of claim 3, wherein modifying the font file includes removing a portion of the font file.

6. The computer-implemented method of claim 3, wherein modifying the font file includes removing a portion of a table from the font file.

7. The computer-implemented method of claim 3, wherein in modifying the font file includes removing a portion of a glyph substitution table.

8. The computer-implemented method of claim 1, wherein sending the font information includes sending a file executable by the asset presenter that contains logic for presenting the typographical features of the web asset represented in the scalable font format.

9. The computer-implemented method of claim 1, wherein the information that indicates whether the asset presenter is capable of presenting one or more typographic features of a web asset represented in a scalable font format is based on operations executed by a font service provider.

10. The computer-implemented method of claim 1, wherein the information that indicates whether the asset presenter is capable of presenting one or more typographic features of a web asset represented in a scalable font format is based on operations executed by the computing device.

11. The computer-implemented method of claim 10, wherein the operations executed by the computing device include reading a cascading style sheet file for determining the typographical features of the web asset.

12. The computer-implemented method of claim 10, wherein the operations executed by the asset presenter include reading information provided from a hypertext markup language file for determining the typographical features of the web asset.

13. The computer-implemented method of claim 12, wherein the web asset presenter reads a document object model for the information provided from the hypertext markup language file.

14. The computer-implemented method of claim 13, wherein the document object model is modified to include a representation of the one or more typographical features of the web asset represented in a scalable font format.

15. The computer-implemented method of claim 2, wherein the font file includes data for a subset of typographical features based on the typographical features of the web asset.

16. The computer-implemented method of claim 2, wherein the font file includes data for a subset of characters based on the content of the web asset.

17. The computer-implemented method of claim 1, wherein the asset presenter includes one of a web browser, a web-based application and a web view application.

18. The computer-implemented method of claim 1, wherein the font information includes the typographical features of the web asset represented in the scalable font format, is absent typographical features that are absent from the web asset, and is provided in one or more files.

19. The computer-implemented method of claim 1, wherein the sent font information includes one or more operations with names that identify one or more typographical features.

20. A system comprising:
a first computing device comprising:
a memory configured to store instructions; and
a processor to execute the instructions to perform operations comprising:
receiving information that indicates whether an asset presenter being executed by a computing device is capable of presenting one or more typographic features of a web asset represented in a scalable font format; and
in response to receiving the information, sending font information to the computing device to allow the one or more typographic features of the web asset represented in the scalable font format to be presented by the computing device.

21. The system of claim 20, wherein sending font information includes sending a font file to the computing device.

22. The system of claim 20, wherein sending font information includes modifying a font file prior to sending the font file to the computing device.

23. The system of claim 22, wherein modifying the font file includes adding one or more character codes to the font file for accessing corresponding glyph shapes.

24. The system of claim 22, wherein modifying the font file includes removing a portion of the font file.

25. The system of claim 22, wherein modifying the font file includes removing a portion of a table from the font file.

26. The system of claim 22, wherein in modifying the font file includes removing a portion of a glyph substitution table.

27. The system of claim 20, wherein sending the font information includes sending a file executable by the asset presenter that contains logic for presenting the typographical features of the web asset represented in the scalable font format.

28. The system of claim 20, wherein the information that indicates whether the asset presenter is capable of presenting one or more typographic features of a web asset represented in a scalable font format is based on operations executed by a font service provider.

29. The system of claim 20, wherein the information that indicates whether the asset presenter is capable of presenting one or more typographic features of a web asset represented in a scalable font format is based on operations executed by the computing device.

30. The system of claim 29, wherein the operations executed by the computing device include reading a cascading style sheet file for determining the typographical features of the web asset.

31. The system of claim 29, wherein the operations executed by the asset presenter include reading information provided from a hypertext markup language file for determining the typographical features of the web asset.

32. The system of claim 31, wherein the web asset presenter reads a document object model for the information provided from the hypertext markup language file.

33. The system of claim 32, wherein the document object model is modified to include a representation of the one or more typographical features of the web asset represented in a scalable font format.

34. The system of claim 21, wherein the font file includes data for a subset of typographical features based on the typographical features of the web asset.

35. The system of claim 21, wherein the font file includes data for a subset of characters based on the content of the web asset.

36. The system of claim 20, wherein the asset presenter includes one of a web browser, a web-based application and a web view application.

37. The system of claim 20, wherein the font information includes the typographical features of the web asset represented in the scalable font format, is absent typographical features that are absent from the web asset, and is provided in one or more files.

38. The system of claim 20, wherein the sent font information includes one or more operations with names that identify one or more typographical features.

39. One or more computer readable media storing instructions that are executable by a processing device, and upon such execution cause the processing device to perform operations comprising:
receiving information that indicates whether an asset presenter being executed by a computing device is capable of presenting one or more typographic features of a web asset represented in a scalable font format; and
in response to receiving the information, sending font information to the computing device to allow the one or more typographic features of the web asset represented in the scalable font format to be presented by the computing device.

40. The computer readable media of claim 39, wherein sending font information includes sending a font file to the computing device.

41. The computer readable media of claim 39, wherein sending font information includes modifying a font file prior to sending the font file to the computing device.

42. The computer readable media of claim 41, wherein modifying the font file includes adding one or more character codes to the font file for accessing corresponding glyph shapes.

43. The computer readable media of claim 41, wherein modifying the font file includes removing a portion of the font file.

44. The computer readable media of claim 41, wherein modifying the font file includes removing a portion of a table from the font file.

45. The computer readable media of claim 41, wherein in modifying the font file includes removing a portion of a glyph substitution table.

46. The computer readable media of claim 39, wherein sending the font information includes sending a file executable by the asset presenter that contains logic for presenting the typographical features of the web asset represented in the scalable font format.

47. The computer readable media of claim 39, wherein the information that indicates whether the asset presenter is capable of presenting one or more typographic features of a web asset represented in a scalable font format is based on operations executed by a font service provider.

48. The computer readable media of claim 39, wherein the information that indicates whether the asset presenter is capable of presenting one or more typographic features of a web asset represented in a scalable font format is based on operations executed by the computing device.

49. The computer readable media of claim 48, wherein the operations executed by the computing device include reading a cascading style sheet file for determining the typographical features of the web asset.

50. The computer readable media of claim 48, wherein the operations executed by the asset presenter include reading information provided from a hypertext markup language file for determining the typographical features of the web asset.

51. The computer readable media of claim 50, wherein the web asset presenter reads a document object model for the information provided from the hypertext markup language file.

52. The computer readable media of claim 51, wherein the document object model is modified to include a representation of the one or more typographical features of the web asset represented in a scalable font format.

53. The computer readable media of claim 40, wherein the font file includes data for a subset of typographical features based on the typographical features of the web asset.

54. The computer readable media of claim 40, wherein the font file includes data for a subset of characters based on the content of the web asset.

55. The computer readable media of claim 39, wherein the asset presenter includes one of a web browser, a web-based application and a web view application.

56. The computer readable media of claim 39, wherein the font information includes the typographical features of the web asset represented in the scalable font format, is absent typographical features that are absent from the web asset, and is provided in one or more files.

57. The computer readable media of claim 39, wherein the sent font information includes one or more operations with names that identify one or more typographical features.

58. The computer-implemented method of claim 1, wherein the font information includes the typographical features of the web asset represented in the scalable font format, is absent typographical features that are absent from the web asset, and is provided in one file concatenated from two or more other files.

59. The system of claim 20, wherein the font information includes the typographical features of the web asset represented in the scalable font format, is absent typographical features that are absent from the web asset, and is provided in one file concatenated from two or more other files.

60. The computer readable media of claim 39, wherein the font information includes the typographical features of the web asset represented in the scalable font format, is absent typographical features that are absent from the web asset, and is provided in one file concatenated from two or more other files.
